(19) United States
(12) Patent Application Publication
(10) Pub. No.: US 2014/0197280 A1
(43) Pub. Date: Jul. 17, 2014

(54) Delta Wing Unmanned Aerial Vehicle (UAV) and Method of Manufacture of the Same

(71) Applicants: Donald Earl Smith, Xenia, OH (US); Mark D. Herres, Englewood, OH (US)

(72) Inventors: Donald Earl Smith, Xenia, OH (US); Mark D. Herres, Englewood, OH (US)

(21) Appl. No.: 13/572,877

(22) Filed: Aug. 13, 2012

Related U.S. Application Data
(60) Provisional application No. 61/629,600, filed on Nov. 22, 2011.

(51) Int. Cl. B64C 3/10; B64D 47/08; B64C 39/02

(52) U.S. Cl. CPC B64C 3/10; B64C 39/024; B64C 39/028; B64D 47/08
USPC 244/35 R

(57) ABSTRACT

This disclosure pertains to the field of small-unmanned aerial vehicles (UAVs). The delta wing vehicle consists of an isosceles triangular shaped lifting body milled from Styrofoam. The longitudinal axis is approximately 65% of the lateral axis. The horizontal wing projections, or tiplets, are attached to the main lifting body at an approximately 10 degree upward angle from horizontal, have a 30 degree sweep back leading edge, and each one comprises 5% of the total wing area. The airfoil is a rhomboid or diamond shape. The chord is swept back at a 45-degree angle from the longitudinal centerline. The airfoil is symmetrical about the longitudinal center. The aircraft is controlled by a set of combined elevator/aileron surfaces (elevons) at the rear as well as a vertical stabilizer/rudder combination. This resulting lightweight UAV can make flat (unbanked) unbanked turns, fly in high winds, and has superior flexibility in payload capability.

### THIS APPLICATION CLAIMS THE BENEFIT OF U.S. PROVISIONAL PATENT APPLICATION #61/629,600 FILED NOV. 22, 2011

### FIELD OF THE INVENTION

This disclosure relates to the field of unmanned aerial vehicles (“UAVs”), which are sometimes known as “drones.” UAVs in this field are remotely controlled air vehicles whose primary use is remote sensing and data gathering. More specifically, the present disclosure relates to small, lightweight UAVs.

### BACKGROUND OF THE INVENTION

The recent advances in technology and related lower operating costs have created compelling reasons for the adoption of UAVs by civil and military end users. Small (under 100 lbs.). UAVs have been under development and in use by military organizations for about 15 years. About 50% of these systems use internal combustion (IC) engines for propulsion and 50% use electric (battery) power for propulsion. IC engines provide adequate power; however such power comes with the additional burdens of increased complexity, less productivity, more noise and difficult logistics in the transport of volatile fuels necessary to power such IC engines. Additionally, based on size and weight, these UAVs require additional support requirements in runways, staff and other services to remain operational. Such requirements hinder private and government organizations from being able to readily implement UAV technology in time-sensitive situations requiring real-time information, such as those involving security threats and large scale disaster response and recovery.

Previously available smaller electric UAVs have attempted to solve these burdens related to IC engines and fuel costs by using battery power, smaller engines and lightweight materials. However, these admittedly smaller UAV electric models, many in the conventional design and shape of an airplane or model airplane¹, sacrifice performance in both power and duration of flight as a result of their smaller size and overall design. These existing electric models often have little to no ability to carry a payload of any kind Additionally, these models are limited in their ability to accommodate a wide range of customizations to meet individual user requirements, such as employing combining sensing technologies like radio frequency identification device (RFID) tracking, carrying cameras and associated hard drives for image storage, reinforcements for impact or collision resistance, or effective alternate power sources in one UAV. These existing models are also extremely susceptible to rain, snow, ice and high winds. This susceptibility limits existing electric UAVs from being able to successfully meet the operational requirements many users, specifically those of military and law enforcement organizations. ¹IDS U.S. Patent Publication, Cite 1

### BRIEF SUMMARY OF THE INVENTION

This disclosure provides a novel solution to the aforementioned limitations in existing UAVs. Currently, there is no lightweight UAV that provides civilian and military users the ability to provide aerial surveillance and signal tracking capability without comprising aircraft performance and flexibility. This application discloses a Delta Wing UAV with a diamond/rhomboid-shaped airfoil that a ground-based operator can launch, fly and land in remote field locations with little to no impact from the elements or terrain. The disclosed embodiment is the first operational UAV capable of weighing less than five (5) pounds, capable of launching and landing without a runway in varied terrain and capable of radio remote or autopilot control. Furthermore, this Delta Wing UAV solves existing limitations with small electric UAV performance, payload and flexibility to be customized to meet user needs through the manufacture and operation of a UAV comprised of a lifting body aircraft with a unique combination of payload capacity, flight duration and flight stability. This Delta Wing UAV is capable of flight in high winds, completing flat turns as opposed to turns requiring banking, and can be customized to meet exacting customer requirements in payload both during the manufacturing process and in the field. These new attributes are presented in an easy to use UAV with operating abilities unmatched by any other aircraft currently in use.

### BRIEF DESCRIPTION OF THE DRAWINGS

FIG. 1 shows a top (overhead) view of the Delta Wing UAV with carbon fiber skin applied.

FIG. 2 shows a bottom (underside) view of the Delta Wing UAV with carbon fiber skin applied.

FIG. 3 shows a profile view of the tail section of the top of the Delta Wing UAV.

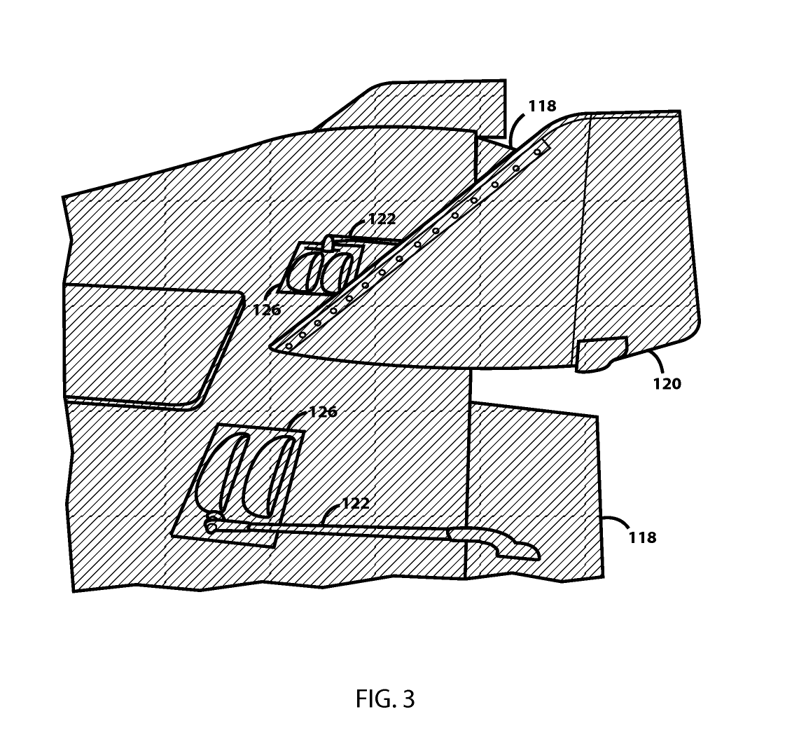

FIG. 4 shows the foam core of the Delta Wing UAV, with upper and lower surfaces covered in carbon fiber skin.

FIG. 5 shows a top view of the Fomey embodiment of the Delta Wing UAV, with a reinforced packing tape covering applied.

### DETAILED DESCRIPTION OF THE INVENTION

### I. Delta Wing UAV

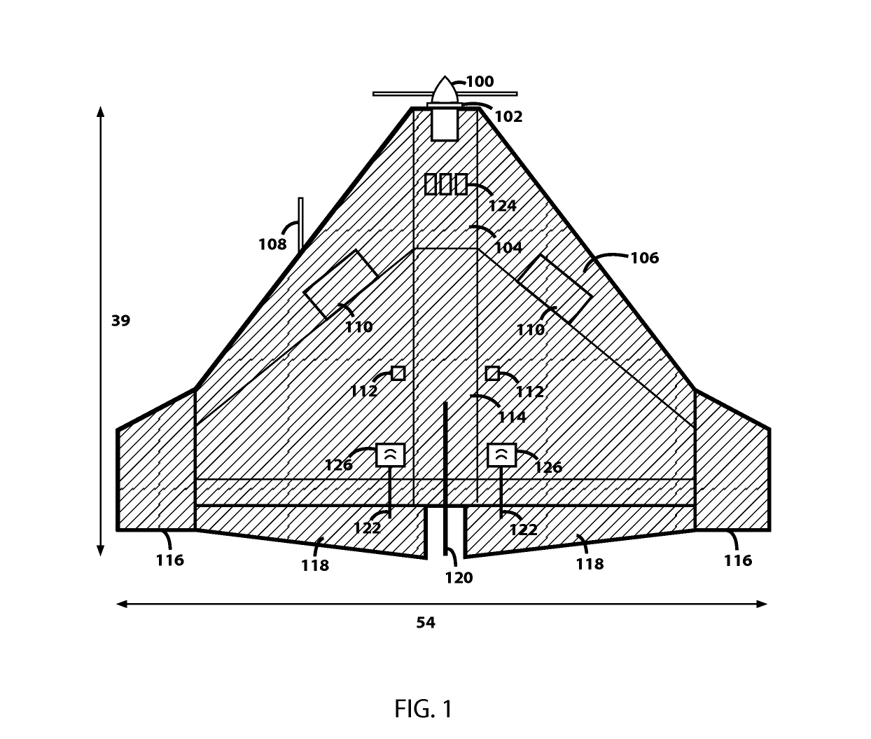

a. Shape and Design. Referring now to the drawings in more detail, FIG. 1 shows a top, or overhead view of the Delta Wing UAV. The UAV consists of an isosceles triangular lifting body 106, here shown with a carbon fiber skin applied, and attached tiplets 116. The longitudinal axis of the lifting body is approximately sixty-five percent (65%) of the lateral axis. The horizontal wing tiplets 116 are attached to the lifting body 106 at approximately a ten degree (10°) upward angle from the horizontal, having a thirty degree (30°) sweep back leading edge, and each one comprising five percent (5%) of the total wing area. The values presented here reflect the preferred embodiment and best mode of the Delta Wing UAV; however a person having ordinary skill in the art will understand there can be slight modifications of these measurements enable the invention. The airfoil is a rhomboid or diamond shape, a feature that is unique in its application to lightweight UAVs. This Delta Wing UAV is symmetrical about its longitudinal center axis.

This Delta Wing UAV lifting body 106 with additional tiplets 116 provides greatly increased stability over traditional UAVs and ordinary delta wing designs found in common some radio controlled toy model airplanes². These tiplets 116 are rectangular in shape, with a junction to the lifting body 106 that puts the tiplets 116 at an upward angle, thus creating a dihedral surface. The tiplets 116 shapes are such that the leading edge of the shape is at less sweepback angle than the lifting body leading edge. The lifting body 106 described in FIG. 1 has a vertical axis of thirty-nine inches (39″) and a horizontal axis at its rearmost portion of thirty-nine inches (39″). Each tiplet 106, as shown in FIG. 1, measures seven and one half inches (7.5″). However, the Delta Wing UAV is fully scalable, with any size being possible without an impact on performance, provided the lifting body's 106 vertical axis and horizontal axis remain equal to one another. Previous experiments have validated such an approach with Delta Wing UAV lifting bodies as large as six feet (6′) at their longitudinal axis and six feet (6′) at their horizontal axis at their rearmost portion. ²IDS, Non Patent Publications, Cite 2

This resulting lightweight UAV's airfoil shape contributes to a low drag, the lifting body contributes a very efficient volume vs. drag characteristic, and the tiplets add exceptional stability and very benign stall performance. Furthermore, and as detailed more below, this shape of the Delta Wing UAV provides an expanded linear surface area, which provides a significant advantage over traditional UAVs, such as those with a traditional fuselage and wing design. One such advantage is the ability to install large, flat antennae on the underside of the Delta Wing UAV, such as those required for RFID tracking Another advantage of this increased surface area arising from this lightweight UAV's unique shape is the ability to apply solar panel film in sufficient quantity to power the Delta Wing UAV for extended flight operations, which is detailed further below.

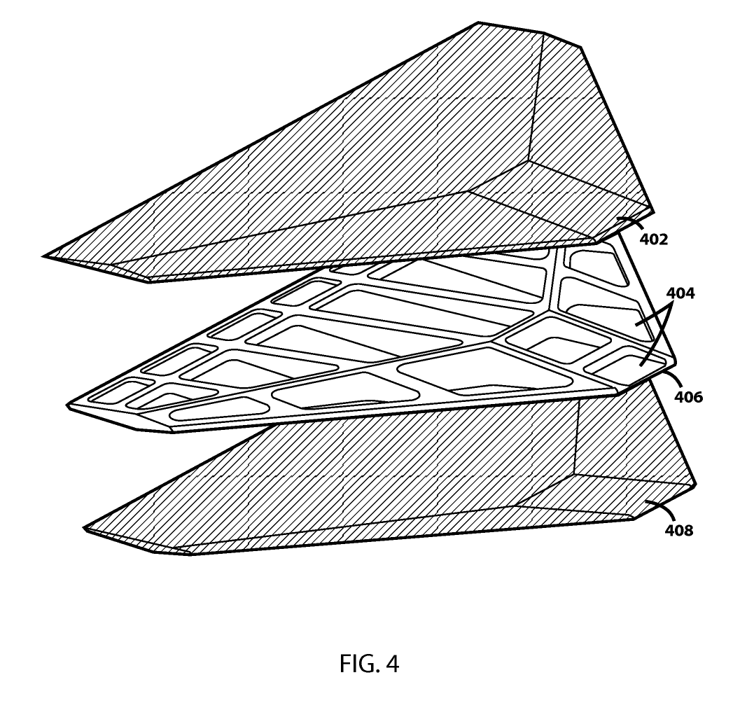

b. Delta Wing UAV Composition and Covering Materials. One of the many advantages of the Delta Wing UAV over existing UAVs in addition to its airfoil shape is the flexibility inherent in both its material composition and the materials that can be applied to its external surfaces to provide enhanced capabilities for users. Referring now to the drawings in more detail, FIG. 4 depicts a foam core 406 with, in this embodiment, its upper surface 408 covered in carbon fiber skin and its lower surface 402 also covered in carbon fiber skin to comprise the Delta Wing UAV lifting body 106. The foam core 406 is made of commercially-available Styrofoam. However, other successful embodiments of the foam core 406 have included expanded polystyrene plastic and other rigid foams. The use of such foams enable the low flying weight and enable the lifting body 106 to be configured with various compartments 404 and modifications to meet user needs. This low flying weight is extremely important for balancing payload and total weight characteristics. Usually, such light weight is a detriment to performance in windy conditions due to forces applied to the body's cross section. In most cases, existing UAVs cannot fly or operators are hesitant to fly them in high winds for fear of loss or damage. This is a significant limitation for a large number of UAV users, especially those working in time-sensitive emergency situations, such as dealing with a natural disaster or recovery therefrom. This Delta Wing UAV's design has a very low cross section, which is much less affected by these winds. The Delta Wing UAV's high stability and predictable stall characteristics are also desirable, as the autopilot computational load is reduced. Void of any payload, the UAV weighs approximately three and one half (3.5) pounds with a camera installed in its central compartment 202. When the outer covering is comprised of a carbon fiber skin, the weight increases minimally to approximately four (4.0) pounds. Depending on the payload, a fully loaded Delta Wing UAV's weight can range from five (5) pounds to eleven (11) pounds. In the embodiment presented, the upper surface 402 and the lower surface 408 are both covered in a carbon fiber skin. Some users of the Delta Wing UAV may prefer the carbon fiber skin embodiment for its strength and durability, as well as the skin's light weight character in enabling the UAV to maintain its low total weight under five (5) pounds.

Another benefit of the Delta Wing UAV's foam composition is the ability to use milled compartments 404 in the lifting body's 106 foam core 406 to lessen the Delta Wing UAV's total weight. For example, in an embodiment in which the carbon fiber skin is applied and numerous devices installed onboard, the UAV lifting body's 106 foam core 406 can be milled with additional, symmetrical empty compartments 404 to lessen the amount of foam present on either side, thus counterbalancing the additional weight from the applied carbon fiber skin and installed onboard devices.

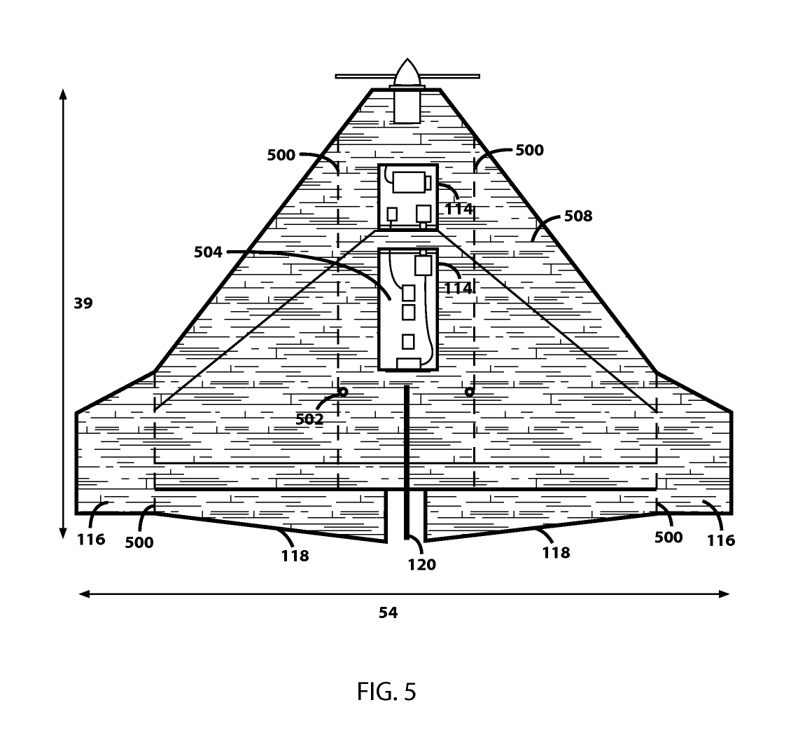

Another Delta Wing UAV embodiment is the Fomey Delta Wing UAV (“Fomey”). Referring to FIG. 5, the six (6) primary components of the Delta Wing UAV are presented. There are two (2) tiplets 116. There are two (2) wings 508. There is a central fuselage 502. And there is a rudder/vertical stabilizer 120. Each tiplet 116 and each wing 508 is detachable from the central fuselage 502 at the seams 500. Each component is connected to the other with pins and a magnet combination as described in the manufacturing process in Section II of this written description. The rudder/vertical stabilizer 120 can be removed from its mount separately. In the Fomey, the covering material is reinforced packing tape with a lateral overlap pattern covering the entire lifting body 106 and the tiplets 116. This embodiment is also called a “Backpack Break Apart ” Delta Wing UAV (“Backpack UAV”), as the six basic components of the UAV are each removable and capable of being packed up and reassembled in another location for flight. (The Delta Wing UAV presented with the carbon fiber skin can also be manufactured to be capable of such rapid assembly and disassembly, however such an embodiment would require separate tooling to apply partial carbon fiber skins to completely encase each of the components.) This Backpack UAV embodiment of the Delta Wing UAV makes it ideal for military and research-oriented users, alike.

Another benefit of the Delta Wing UAV's foam composition is the resulting buoyancy. In the event of crash, the Delta Wing UAV is capable of floating on water for ease of location and recovery. Secondly, whether implemented with a carbon fiber skin or in its Fomey embodiment, the compartments can remain air and watertight. This protects against water and contaminant damage, which can result in increased costs, mission failure and loss of data, depending on the payload.

Another Delta UAV Wing embodiment is that in which the covering material is comprised of commercially available solar panel film rather than carbon fiber skin or tape, enabling the UAV to obtain solar energy and convert it to electrical power for the UAV³. Such an application of solar panel film to small UAVs is not unique to the Delta Wing UAV described in this application. However, the Delta Wing UAV design used with the solar panel film is significantly superior to existing applications of the solar panel film, or actual panels, to other UAV available at this time. For example, some applications of solar panels to existing UAVs provide some power to UAVs that require 120 watts of maintain constant power to the UAV during daylight hours. However, because the reduced surface area of existing UAVs is not sufficient to carry the necessary solar panels to meet this total required wattage for extended daytime flight without battery power, existing UAV technology cannot sustain expanded flight times. ³IDS Non Patent Publication, Cite 1

This embodiment of the Delta Wing UAV provides two significant improvements over these existing UAV solar power applications. First, on average, the Delta Wing UAV has nearly triple the surface area upon which solar panels can be applied as to that of standard UAVs⁴. While a sailplane with a very large wingspan would also have a similar surface area capacity, such a sailplane concedes the superior flight capabilities present in the Delta Wing UAV. Furthermore, the Delta Wing UAV only requires 90 watts of constant power to operate. This additional surface area enables the Delta Wing UAV to capture a surplus of 30 watts of power from solar cells. This surplus can then be used thus to recharge its onboard batteries during sun lit conditions. The solar cells present in the solar panel film applied to the Delta Wing UAV upper surface and lower surfaces convert photon energy from sunlight to electric potential. This voltage is then processed by a voltage regulator to control the voltage applied to the battery bus. This regulated voltage powers the motor 100 and payload. Any excess is used to recharge the onboard battery. In such a configuration, when combined with the onboard battery supply, this embodiment of the Delta Wing UAV covered with the solar panel film provides the Delta Wing UAV up to 14.5 hours of uninterrupted flight time. ⁴IDS Non Patent Publication, Cite 1

c. Delta Wing UAV Flight Control. Delta Wing UAV flight is controlled with two tapered surfaces at the trailing edge of the body, right and left elevator/aileron surfaces, or elevons 118. These elevons 118 are typical of those used in the field of radio remote-controlled aircraft. The elevons 118 control both pitch and the roll axis. The servo actuators with louvered covers 126 are connected to the elevons 118 with pushrods 122. It is the presence of these elevons 118 that enable the Delta Wing UAV to fly and turn “flat” or without banking UAVs with only rudder control must make wide turns and bank to change directions. Such turns and change in the vehicle's orientation reduce the response times and consistency in sustained performance of these existing UAVs limited to rudder control.

The openings present in the louvered covers provide an exhaust point for internal cooling. A large vertical stabilizer and rudder 120 is centered on the top rear portion of the body. The rudder surface imparts yaw control and longitudinal stability, providing the operator the ability to control the UAV's left/right movement. The vertical cross section is a small percentage of the wingspan. When combined with the lifting body 106 and tiplets 116, this rudder/vertical stabilizer 120 permits very low drag losses compared with other UAVs. This low profile presents little or no side surface area, so the Delta Wing UAV is not affected by cross winds.

The rudder 120 and elevons 118 can be controlled electronically via a radio remote control device, similar to any commercially available radio remote control device. In its preferred embodiment for radio remote control, a 2.4 GHz radio controller is used. The radio control receiver controls the servo actuators 126 directly from the hand-held transmitter control sticks controlled by a ground-based human operator. The onboard radio remote control device is installed within one of the internal compartments 210 with its related antenna 208 extending from the seam present at the junction of the lifting body 106 and either tiplet 116. In another embodiment in which the user requires other onboard devices requiring ground communications or devices requiring two antennas, antennae 208 can extend from the seam 500 between either tiplet 116 and the lifting body 106 on either wing 508.

In another embodiment, a commercially available auto pilot device 504 installed in a Delta Wing UAV compartment 114 can also control the rudder 120 and elevons 118. Any commercially available auto pilot device 504 for remote controlled aircraft can be used, provided it fits within the compartments milled into the lifting body's 106 foam core 406. In one embodiment, this autopilot device is paired with a global positioning system (GPS) device and antenna 112. A ground-based computer can be programmed with multiple GPS coordinates or “way points”, enabling the Delta Wing UAV to fly from coordinate to coordinate and then land at a final designated coordinate. As with the radio remote control device, the auto pilot device communicates with the ground-based computer using the antenna 208. The autopilot device controls the servos according to its programmed flight path instructions, which are received from the ground station via a radio link. The autopilot employs an internal inertial platform to maintain the pitch, roll, and yaw orientations of the UAV. There is an air speed tube 108 that provides the autopilot system with airspeed and altitude information. A GPS receiver with its associated antenna 112 provides navigation positioning information to permit following the commanded path.

Regardless of the embodiment implemented, the Delta Wing UAV can be either hand-launched or launched on a rail system powered by rubber bungees. In such an embodiment in which the UAV is launched from a rail system, the landing guides 204 serve to guide the UAV along the rail and as a reference for landing. Furthermore, the UAV can land safely on any flat surface or into a net.

d. Delta Wing UAV Propulsion and Power Management. In the preferred embodiment, Delta Wing UAV electric power is provided by a commercially available 3-phase alternating current (AC) brushless motor 100 mounted to the front center of the aircraft with a traditional bracket motor mount 102 commonly used with remote controlled airplanes. The motor 100 as presented in this embodiment is capable of powering the aircraft to top speeds of one hundred forty-five (145) miles per hour (mph). In the alternative, such a motor 100 can be similarly mounted at the rear center of the aircraft using the same mount 102. However, such a configuration would require the addition of an extended mount (pylon) to place the motor's 100 propeller clear of the flight control surfaces. The electric power is primarily, but not exclusively, used for UAV propulsion through the air, thus presenting low cross section and drag. The Delta Wing UAV also uses the electricity to power onboard devices, such as, but not limited to, autopilot control systems, radio control systems, infrared cameras and LED lighting.

In its preferred embodiment, the Delta Wing UAV contains two (2) batteries, installed symmetrically in two (2) compartments on either side of its longitudinal axis. The batteries are Lithium-Polyvinyl (LI-POLY) and are commercially available. Traditionally, light aircraft use 3 cell (11.1 volt) 5-ampere hour batteries, while heavier aircraft use 5 cell (18.5 volt) 5 ampere hour batteries. The batteries chosen are specific to the user's specifications related to weight, flight duration and other factors. The batteries are connected to the central compartment 114 via commercially available electrical conduit capable of carrying a twelve-volt (12V) DC current. Commonly available “Y” connections can be used to connect multiple onboard devices with this power supply. The batteries can be charged directly by the system or can be recharged via solar panel film as presented above in one embodiment.

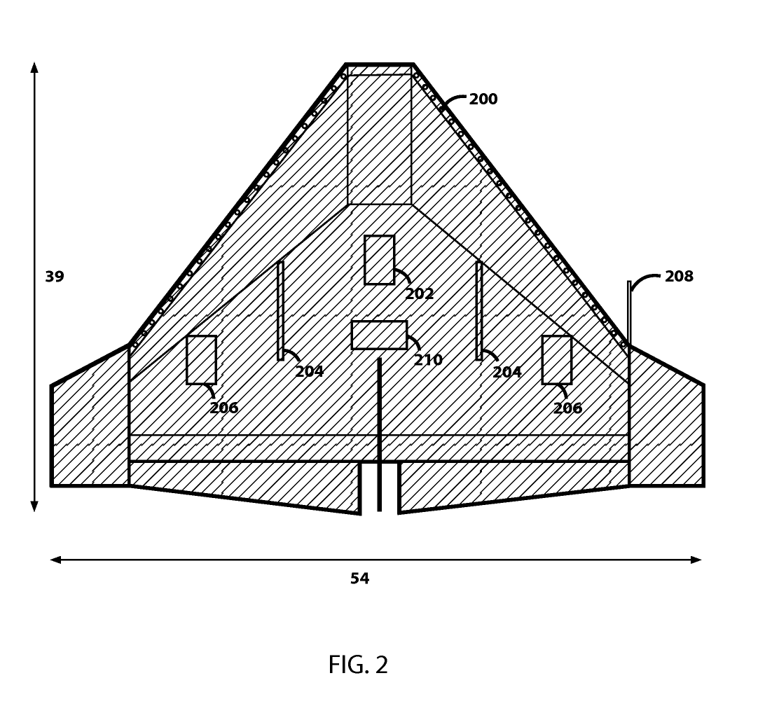

e. Delta Wing UAV Customizations. Because of its foam core 406 dihedral shape, the present disclosure provides superior capabilities to be customized to meet individual user requirements. These customizations include, but are not limited, to the following:
i. Camera Housing. As presented in the drawings, a centrally located camera compartment 202 is located on the underside of the Delta Wing UAV, between the landing guides 204. The compartment can support the storage and wiring requirements of variety of cameras, with a four (4) ounce infrared (IR) camera being the most commonly used. The compartment's configuration is designed for easy access to ensure the user's ability to service or replace the camera. Electric power for the camera is provided through standard “Y connectors” wired through the central compartment 114 to the battery compartments 110.
ii. LED Lighting. As presented in FIG. 2, one embodiment of the Delta Wing UAV includes the attachment of LED lights 200 along the two leading edges of the lifting body 106. LED lights can be affixed to any leading edge of the UAV. These lights serve two purposes. First, because the UAV can be controlled by radio remote control, the LED lighting enables the ground-based human controller to view the UAV at night or in poor weather conditions such as heavy rain. Secondly, when weather conditions preclude line-of-sight capabilities for the ground-based human operator, the LED lights 200 enable the UAV to be detected by infrared camera. Power for the LED lights is provided through standard “Y connectors” wired through the central compartment 114 to the battery compartments 110.
iii. Radio Frequency Identification Device (RFID) Tracking. In one embodiment, the Delta Wing UAV's compartment 210 and wiring also enable the inclusion of a RFID transmitter, capable of transmitting and recording the location information reported back from ground-based active RFID tags. More specifically, in recent experiments with the Delta Wing UAV, the onboard RFID system was able to read RFID tags located on the ground from a distance of two (2) miles. Power for the RFID control unit located in the UAV compartment 210 and any associated antenna 208 is provided through standard “Y connectors” wired through the central compartment 114 to the battery compartments 110.

As previously discussed, the Delta Wing UAV's design and shape enable the installation of large patch antennae as those required for RFID systems. This linear design for antenna installation combined with the UAV's elevon 118 flight control, which enable the UAV to turn without banking, distinguish another significant advantage of the Delta Wing UAV over existing lightweight UAV technology. Rudder-only UAVs require wide turns and banking Such turns require existing UAVs to direct the RFID antenna away from RFID tags on the ground. This results in an interruption, if not a complete loss, of the stream of data being tracked by the UAV. The Delta Wing UAV eliminates this problem by enabling the sensors to remain in constant contact with their RFID tags, even while making “flat turns”. These “flat turns” enable the RFID sensor ports 206 located on the underside of the Delta Wing UAV to remain in contact with their ground-based RFID tags.
iv. In-Time Structural Modifications. When implemented in the Fomey embodiment described above, in which reinforced packing tape is used as the covering material, users such as those conducting research, can carve out new compartments to install or remove items with a cutting device and reinforced packing tape. Provided such modifications are made symmetrically on both sides of the longitudinal axis of the lifting body 106, the Delta Wing UAV can maintain the same flight capabilities and remain capable of an endless number of modifications in response to in-time, field-based user needs.

### II. Delta Wing UAV Manufacturing Process

The following detailed description discloses the process necessary to manufacture the Delta Wing UAV. The manufacturing process commences with a standard computer numerical control (CNC) milling of a foam block to the shape of the foam core 406. User specifications can be provided in computer-aided design (CAD) or computer-aided manufacturing (CAM) program files. A person having ordinary skill in the art of such milling practices using CAD and CAM programs will have the needed expertise to complete the manufacture as described herein. The preferred foam for such milling is Styrofoam, however other successful embodiments have included expanded polystyrene plastic and other rigid foams. The use of such materials is essential to both the lightweight characteristic of the Delta Wing UAV and its ability to support multiple configurations to meet user requirements for different payloads and flying weight requirements. The preferred milling produces the foam core 406 as shown in FIG. 4. Likewise, the tiplets 116 are likewise finished in the same covering materials. Furthermore, the longitudinal axis compartments 404 throughout the foam core 406 are milled according to the user's specifications presented in a CAD or CAM file.

Once properly milled, foam core 406 has a plywood former inserted horizontally in the nose section for the UAV motor mount 102. Flight control servo actuators with louver covering 126 are inserted in pockets cut in the lifting body 106, and flight control surfaces attached to the trailing edge of the wing which has had a wood strip attached to it to permit satisfactory hinge performance. A slot is routed in the body horizontally from wingtip to wingtip, and a carbon fiber bar is inset to act as a lateral wing reinforcement (spar). The slot is located at the rear of the main payload bay. A shallow rectangular wood box is inserted in a routed slot at the rear centerline, which acts as the socket for the rudder/vertical stabilizer 120. Two carbon fiber tubes are inserted into each outer wing tip attachment area and retained with adhesive. The lateral position of the tubes matches the pins inserted in the tiplets 116. The locating pins consist of a main spar and two anti-rotation pins. The main spar pin/socket is a ¼ inch square OD carbon fiber extrusion and ¼ in ID extrusion pair. The larger extrusion is glued into a horizontal slot in the main body with urethane glue and the smaller extrusion is similarly glued into a slot in the wing sections with a two inch length extending for mating with the main body socket. A ⅛ inch OD CF rod is glued into slots in the front and rear of the wing sections and mates with a ⅛ inch ID CF tube glued in horizontal slots in the main wing section. This spar/pin system provides the structural support and positioning functions between main body and wings. Both the main body and wing section mating surfaces are terminated with a ⅛ inch plywood cap to provide a “finished” surface for mating. Embedded and glued into these plywood caps are disc magnets that provide retention force between the sections. The magnets are Magcraft®⁵ NSN0573 ⅜ inch in diameter and ⅛ inch thick rare earth magnets with four pound (4 lb.) attraction force. ⁵Magcraft is a registered trademark of National Imports LLC

The wing tiplet 116 shapes, also cut and milled from foam, have two locating pins inserted with adhesive to correctly position the dihedral angle of each tiplet 116 to the lifting body 106. The tiplets 116 are then covered in either a carbon fiber skin or reinforced packing tape with a lateral overlap pattern to make the Fomey embodiment previously described. The vertical stabilizer/rudder assembly 120 is inserted in the wood slot at the rear centerline and retained with two bolts that are located horizontally and pass thru the entire box and fin structure at the front and rear of the box and are terminated in blind nuts. The flight control servo actuators with louver covering 126 are attached to the lifting body 116 and elevons 118 with a pushrod 122 and horn assembly configured for ease of removal for maintenance and repair. The electric motor 100 is attached to the front horizontal plate with a rectangular mount fixture and thru bolts 102. The motor 100 electrical leads are connected in a compartment 104 to batteries installed symmetrically in battery storage compartments 110. Air inlets 124 are inserted into compartment 104 to provide internal cooling. Larger compartments 404 may have molded plastic “tubs” inlaid into their cutouts and retained with adhesive. Rectangular sheet covers for the bays are held in position using a system of magnets for positive location but ease of removal. The magnets are embedded in the corners of the payload bay cutouts and mate to steel washers glued to the underside of the hatch covers. These magnets are rectangular bar magnets ⅛ inch square and ¾ inches long. They are embedded vertically for better adhesion to the body core. In one embodiment, the autopilot system 504 may be installed in the central compartment 114. The foam core 406 is then bonded to its carbon fiber skin with adhesive on its upper surface 402 and lower surface 408. The adhesive is then allowed to cure for 12 hours.

In the manufacture of an alternate embodiment of the Delta Wing UAV in which enhanced impact resistance is desired, the foam core 406 is further milled to create ribs and pockets in the same basic compartment shapes, including the payload bays. A thin carbon fiber bottom surface shell, which has been created in a separate mold, is placed in a locating fixture.

After curing is complete, the foam core middle 406 is finished as described above to the point of tape attachment. In the embodiment in which carbon fiber skin is required, a second carbon fiber shell is bonded to the upper surface 402 and the lower surface 408. The resultant Delta Wing airframe retains the lightweight character of the foam with the impact resistance and rugged nature of the carbon fiber skin. A matching set of carbon fiber skin shells are bonded to the tiplets 116 and elevons 118 in the same manner. The rudder 120, which is made from commercially available carbon fiber or a fiber/balsa wood sandwich material, is not covered in either the carbon fiber skin or packing tape, depending on the embodiment preferred by the user.

The various embodiments of the UAV as described herein, may be implemented in the materials described, or similar materials of which a person having ordinary skill in the art would comprehend. Although exemplary embodiments have been shown and described, it will be clear to those of ordinary skill in the art that a number of changes, modifications, or alterations, to the disclosure as described may be made. All such changes, modifications, and alterations should therefore be seen as within the scope of the disclosure.

What is claimed is:

1. A lightweight unmanned aerial vehicle comprised of a Styrofoam scalable delta wing lifting body with attached Styrofoam horizontal wing projections, or tiplets, creating a dihedral surface and diamond/rhomboid-shaped symmetrical airfoil controlled with a rudder/vertical stabilizer assembly and a set of rear combined elevator/aileron surfaces (elevons), in which the vehicle's longitudinal axis is approximately sixty-five percent (65%) of the lateral axis and the tiplets are attached to the main lifting body at an approximately 10 degree upward angle from horizontal and have a 30 degree sweep back leading edge, and each tiplet comprises approximately 5% of the total wing area.

2. A method of manufacture in which body, airfoil and tiplets of the lightweight unmanned aerial vehicle of claim 1 are milled from a Styrofoam block, and the rudder/vertical stabilizer and elevons are attached to the lifting body.

3. The lightweight unmanned aerial vehicle of claim 1 on which a carbon fiber skin covering is applied.

4. The lightweight unmanned aerial vehicle of claim 1 on which a reinforced packing tape covering is applied.

5. The lightweight unmanned aerial vehicle of claim 1 on which a solar power panel skin covering is applied.

6. The lightweight unmanned aerial vehicle of claim 1 in which a radio remote control device is installed.

7. The lightweight unmanned aerial vehicle of claim 1 in which an autopilot control device is installed.

8. The lightweight unmanned aerial vehicle of claim 1 in which the lifting body and tiplets are composed of expanded polystyrene plastic.

9. The lightweight unmanned aerial vehicle of claim 1 in which the tiplets, wings, fuselage and rudder are detachable for rapid assembly and disassembly.

10. The lightweight unmanned aerial vehicle of claim 1 in which a camera is installed.

11. The lightweight unmanned aerial vehicle of claim 1 in which an RFID transmitter and sensors are installed.

12. The lightweight unmanned aerial vehicle of claim 1, in which the chord is swept back at a 45-degree angle from the longitudinal centerline.
